(19) United States
(12) Patent Application Publication
(10) Pub. No.: US 2026/0196897 A1
(43) Pub. Date: Jul. 9, 2026

(54) CONDUCTOR FOR AN ELECTRIC MACHINE

(71) Applicants: SAFRAN ELECTRICAL AND POWER UK LTD, Pitstone Buckinghamshire (GB); SAFRAN, Paris (FR)

(72) Inventors: Paul David FLOWER, Pitstone Buckinghamshire (GB); Sabrina Siham AYAT, Paris (FR)

(21) Appl. No.: 18/868,892

(22) PCT Filed: May 27, 2022
(86) PCT No.: PCT/IB2022/000360

§ 371 Date: Nov. 25, 2024

(51) Int. Cl. H02K 3/02; B33Y 80/00; H02K 1/14; H02K 15/0407; H02K 21/22

(52) U.S. Cl. CPC H02K 3/02; B33Y 80/00; H02K 1/146; H02K 15/0407; H02K 21/22

(57) ABSTRACT

The following abstract will replace all prior versions of the abstract in the application:
A conductor for an electric machine, and a method of making the conductor. The conductor includes two zones of higher electrical conductivity; and a zone of lower electrical conductivity. The zone of lower electrical conductivity comprises-includes an electrically conductive material having a plurality of discontinuities in the electrically conductive material to provide the zone of lower electrical conductivity with a lower electrical conductivity than the zones of higher electrical conductivity. The zone of lower electrical conductivity separates the two zones of higher electrical conductivity along a lengthwise direction of the conductor.

### FIELD OF THE INVENTION

The present invention relates to an electric machine, and in particular to a conductor for an electric machine.

### BACKGROUND OF THE INVENTION

Electric machines include at least one current carrying component, in the form of an electrically conductive conductor or wire. Energy losses when passing current through the conductor can be detrimental to performance of the electric machine. These losses can arise from: resistance in the wire to direct current (“DC”) electron flow; losses due to skin effects; and losses due to eddy currents.

Losses typically cause an increase of the temperature in the electric machine. A lower temperature, typically achieved by active cooling, often defines the maximum performance of an electric machine, so reducing energy losses from the conductor can significantly improve performance.

For inverter-driven electric machines operating at a high fundamental frequency, the resistive (DC) component of losses is relatively small. A high fundamental frequency may be at least 1 kHz, or may be more than 10 kHz. For example, the total losses in a copper wire can be 2.5× higher when subjected to alternating current (“AC”), compared running the same direct current through the same wire. A substantial portion, or a majority, of these losses may be a result of noise created by the inverter switching frequency, which may have a frequency of at least 10× the fundamental frequency of the electric machine. The inverter switching frequency of an inverter-driven electric machine may be at least 10 kHz, optionally may be at least 20 kHz.

In inverter-driven machines running at more modest frequencies, skin effects can be relatively low, and a greater proportion of losses can be due to eddy currents, with these currents flowing perpendicular to the intended direction of travel. A modest frequency may be less than or equal to 1 kHz.

A common solution to eddy currents and skin effects is use of Litz wire. A Litz wire comprises a plurality of conductors, i.e. wires, each independently insulated from one another, and braided or twisted in a specific arrangement. Each conductor of a known Litz wire is uniform in makeup and conductivity. Each conductor of a known Litz wire comprises homogeneous conductive material.

Insulation between the wires may comprise enamel, and prevents the wire from acting like a bar wire and experiencing skin and eddy current effects. Twisting or braiding the wires unifies the electromotive force (“EMF”) applied to each wire, which avoids circulating currents within the wires and balances current flow across all wires, which also reduces energy losses. The combination of insulation between wires and braiding gives a conductor having reduced energy losses.

However, Litz wire can be expensive to manufacture, difficult to assemble into a stator, and in an electric machine the slot fill factor can be poor. Heat dissipation from Litz wire can also be restricted due to low thermal conductivity of the wire insulation, such as enamel, within the bundle of Litz wires.

There is therefore a need for improvements in conductors for electric machines.

### SUMMARY OF THE INVENTION

A first aspect of the invention provides a conductor for an electric machine,
wherein the conductor comprises:
   two zones of higher electrical conductivity; and
   a zone of lower electrical conductivity, comprising an electrically conductive material having a plurality of discontinuities in the electrically conductive material to provide the zone of lower electrical conductivity with a lower electrical conductivity than the zones of higher electrical conductivity;
   wherein the zone of lower electrical conductivity is disposed between the two zones of higher electrical conductivity, so as to at least partly separate the two zones of higher electrical conductivity along a lengthwise direction of the conductor.

This aspect has the advantage of reducing energy losses due to eddy currents and skin effects, without inhibiting current flow in a lengthwise direction of the conductor. Specifically, zones of higher electrical conductivity permit current flow without restriction along a lengthwise direction of the conductor, while zones of lower electrical conductivity restrict current flow in a lateral direction of the conductor. This directional conductivity reduces eddy currents and associated energy losses. This aspect also provides a conductor that is simple and cheap to manufacture. This aspect also provides a conductor having improved thermal conductivity. Compared to the insulation in a Litz wire, for example, the zone of lower electrical conductivity has improved thermal conductivity.

The conductor may be additively manufactured. The conductor may have a microstructure indicative of having been manufactured using additive manufacture. Additive manufacture may involve depositing particles, and sintering or otherwise fusing together deposited particles, for example by using an energy beam. This has the advantage of providing a conductor that is simple and cheap to manufacture.

The conductive material of the zone of lower electrical conductivity may have substantially the same chemical composition as the material of the zones of higher electrical conductivity. This has the advantage of providing a conductor that is simple and cheap to manufacture. The one or more zone(s) of lower electrical conductivity and/or the zones of higher electrical conductivity may comprise copper. This has the advantage of providing a conductor having no thermal limit.

The zone of lower electrical conductivity may comprise a plurality of particles. The discontinuities may be voids or pores between the particles. The discontinuities may be cracks or microcracks at points where particles are closest or touch, i.e. at junctions between particles, and/or discontinuities may be voids between particles. The zones of higher electrical conductivity may comprise a plurality of sintered particles. The zone of lower electrical conductivity may be more porous than the zones of higher electrical conductivity. The discontinuities may comprise voids, gaps, cracks or micro-cracks.

The zones of higher electrical conductivity may be joined to one another by the zone of lower electrical conductivity. The zones of higher electrical conductivity may be mechanically connected to one another by the zone of lower electrical conductivity. The zones of higher electrical conductivity may have a higher density than the zone of lower electrical conductivity.

Along a lengthwise direction of the conductor, there may be at least one longitudinal portion or area without any zone of lower electrical conductivity. This has the advantage of providing a conductor that can reduce energy losses in areas where energy losses would typically be detrimental, while having a high conductivity in areas where energy losses are less likely, or less detrimental to overall performance of the electric machine.

The zone of lower electrical conductivity may extend in a lengthwise direction of the conductor. The zone of lower electrical conductivity may extend substantially parallel to an outer surface of the conductor. The zone of lower electrical conductivity may be substantially uniform along its length. This has the advantage of providing a particularly effective arrangement, in which conductive channels for DC current flow are provided between or around the zone(s) of lower electrical conductivity.

One or more bridging portions may be provided across the zone of lower electrical conductivity, to mechanically and/or electrically connect the zones of higher electrical conductivity to one another. This has the advantage of providing a conductor with improved structural or mechanical integrity.

The conductor may comprise a plurality of zones of lower electrical conductivity. Optionally, the conductor comprises at least three zones of lower electrical conductivity. The plurality of zones of lower electrical conductivity may run in parallel to one another along a lengthwise direction of the conductor. This provides a conductor with reduced energy losses. The conductor may comprise at least three zones of higher electrical conductivity.

Bridging portions across different zones of lower electrical conductivity may be spaced apart from one another in a lengthwise direction of the conductor. This provides a conductor with reduced energy losses.

The zone or zones of lower electrical conductivity may be arranged so as to reduce eddy currents within the conductor. The zones of higher and lower electrical conductivity are preferably arranged so as to inhibit lateral current flow within the conductor. The zones of higher and lower electrical conductivity are preferably arranged so as to permit longitudinal current flow within the conductor. The zone or zones of lower electrical conductivity are preferably arranged so as to mimic insulative layers between conductors in a Litz conductor arrangement. This may be, for example, by being arranged in a sinusoidal, or helical arrangement. This may be in a braided, plaited or woven arrangement.

There may be provided an electric machine comprising windings. The windings may comprise the conductor as described herein. The electric machine optionally comprises at least one rotor and at least one stator. The conductor may be disposed in a slot or plurality of slots within the rotor or stator. An area of the conductor within the slot or slots may have zones of lower electrical conductivity. An area of the conductor outside of the slot or slots may be devoid of zones of lower electrical conductivity.

According to a second aspect, there is provided a method of manufacturing a conductor for an electric machine, comprising:
forming two zones of higher electrical conductivity,
forming a zone of lower electrical conductivity, comprising an electrically conductive material having a plurality of discontinuities in the electrically conductive material to provide the zone of lower electrical conductivity with a lower electrical conductivity than the zones of higher electrical conductivity;
such that the zone of lower electrical conductivity is disposed between the two zones of higher electrical conductivity, so as to at least partly separate the two zones of higher electrical conductivity along a lengthwise direction of the conductor.

This aspect has the advantage of producing a conductor having reduced energy losses due to eddy currents and skin effects, without inhibiting current flow in a lengthwise direction of the conductor.

Forming the two zones of higher electrical conductivity, and/or forming the zone of lower electrical conductivity, may be performed using an additive manufacturing process or processes.

Forming the zone of lower electrical conductivity may involve depositing particles. Forming the two zones of higher electrical conductivity may involve depositing particles, and may involve sintering the deposited particles.

Forming the zone of lower electrical conductivity may involve manufacturing gaps, cracks or micro-cracks.

### BRIEF DESCRIPTION OF THE DRAWINGS

Embodiments of the invention will now be described with reference to the accompanying drawings, in which:

FIG. 1 is a schematic illustration of an aircraft comprising an electrical system;

FIG. 2 is a cross-sectional view of a conductor;

FIG. 3 is a partial cut-through perspective view of a first embodiment electric machine;

FIG. 4 is a cross-section through the electric machine of FIG. 3;

FIG. 5 is an enlarged view of a cross-section through a conductor of the electric machine of FIG. 3;

FIG. 6 is a cross-section through part of a second embodiment electric machine;

FIG. 7 is an enlarged view of a slot of electric machine of FIG. 6;

FIG. 8 is a graph showing modelled AC vs DC losses in different variations of conductor; and

FIG. 9 is a cross-section through a conductor of an electric machine.

### DETAILED DESCRIPTION OF EMBODIMENTS

The following detailed description and figures provide examples of how the present invention can be implemented and should not be seen as limiting examples, rather illustrations of how the various features of the conductor can be combined or used. Other optional variations and combinations will be evident upon a reading of the following description in light of the figures.

Features of the present invention are defined in the appended claims. While particular combinations of features have been presented in the claims, it will be appreciated that other combinations, such as those provided above, may be used.

As used herein, the terms: “zone of lower electrical conductivity” and “zone of higher electrical conductivity” are defined relative to one another, in that the zone of lower electrical conductivity has a lower electrical conductivity than the zone of higher electrical conductivity. The zone of lower electrical conductivity is electrically conductive, but is more resistive to current flow than the zone of higher electrical conductivity.

The conductor of the present invention is configured for use in an electric machine, which may be used in an aircraft.

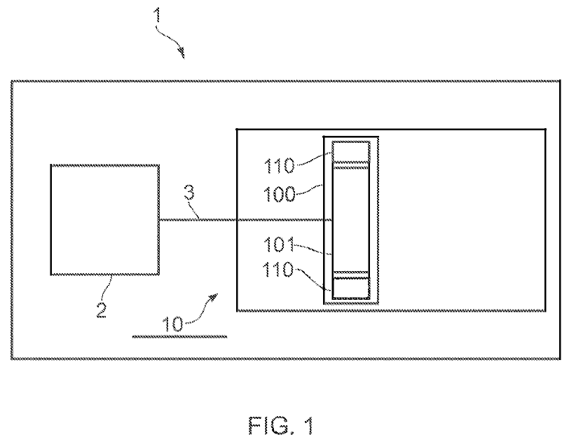

An aircraft 1 is schematically represented in FIG. 1. The aircraft 1 comprises a prime mover 2, shaft 3 and an electric machine 100 in an electrical system 10.

The electric machine 100 may be arranged as a generator configured to deliver power to accessories of the aircraft 1, and/or to provide motive power to a propulsion system of the aircraft, such as one or more propellers. The electric machine 100 comprises a rotor 101 and a stator 110. The rotor 101 may be configured to carry a plurality of permanent magnets. The stator 110 may comprise a plurality of electrical conductors. Equally, the rotor 101 may be configured to carry a plurality of electrical conductors, and the stator 110 may comprise a plurality of permanent magnets.

As the rotor 101 is rotated about the axis of rotation within the stator 110, the magnetic field of the rotor 101 is also rotated. This causes a rotating magnetic field which interacts with the electrical conductors and thus generates a voltage with the electrical conductors in a usual manner.

As described previously, energy losses when passing current through the conductor(s) can be detrimental to performance of the electric machine. These losses can arise from: resistance in the wire to DC electron flow; losses due to skin effects; and losses due to eddy currents. The present invention mitigates these energy losses, in particular the energy losses from eddy currents.

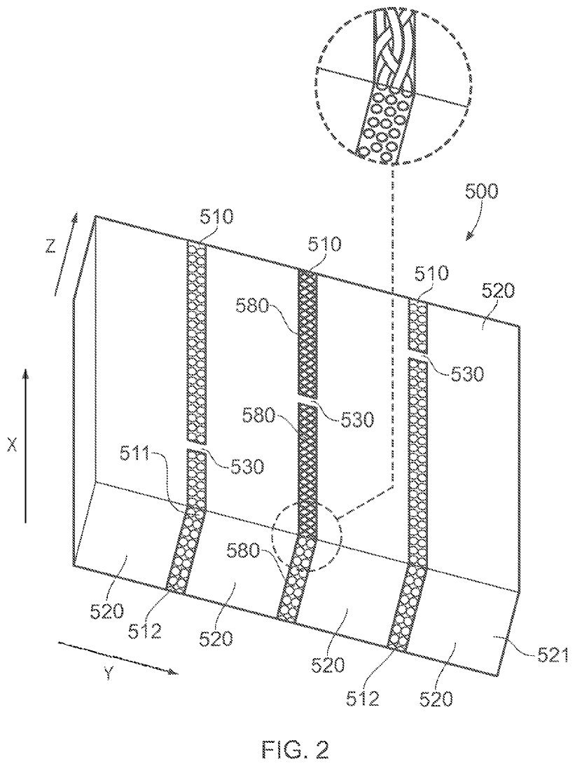

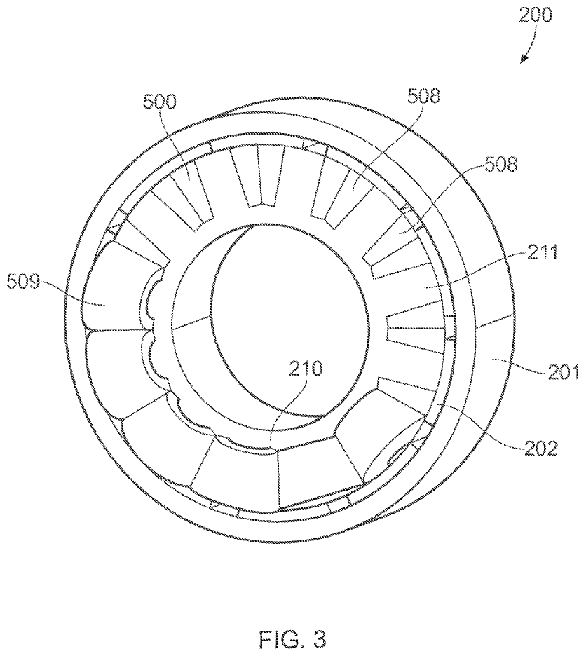

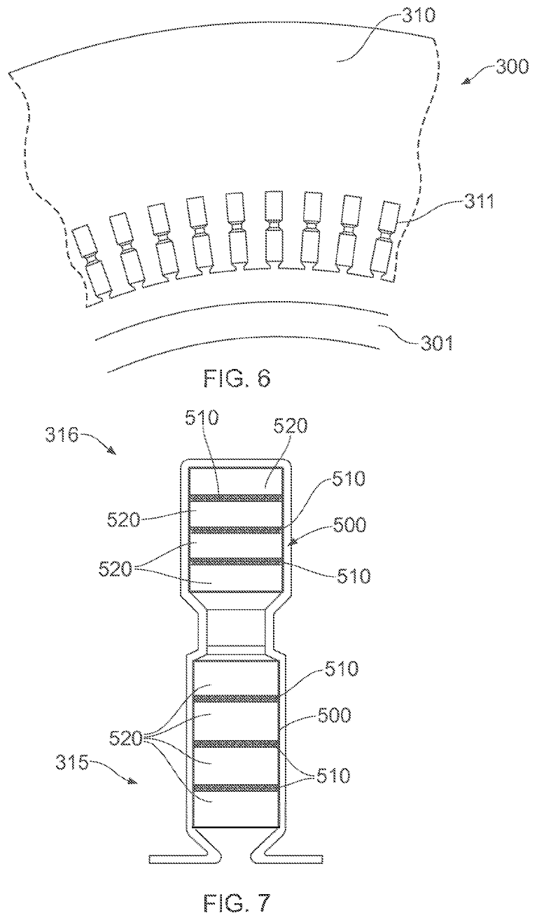

An embodiment of the conductor 500 of the present invention is shown in FIG. 2. The conductor installed in a first embodiment of an electric machine 200 is shown in FIGS. 3 to 5. The conductor 500 installed in a second embodiment of an electric machine 300 is shown in FIGS. 6 and 7. The skilled person will appreciate the conductor 500 may be installed in different variations or embodiments of electric machines, which may not be described or shown here.

The or each conductor 500 comprises: two zones of higher electrical conductivity 520; and a zone of lower electrical conductivity 510. The zone of lower electrical conductivity 510 comprises an electrically conductive material having a plurality of discontinuities 512 in the electrically conductive material to provide the zone of lower electrical conductivity 510 with a lower electrical conductivity than the zones of higher electrical conductivity 520. As shown in FIG. 2, the zone of lower electrical conductivity 510 is disposed between the zones of higher electrical conductivity 520, so as to at least partly separate the two zones of higher electrical conductivity 520 along a lengthwise direction X of the conductor 500.

The conductor 500 may be additively manufactured. The conductor 500 may have a microstructure indicative of having been manufactured using additive manufacture.

As used herein, the term “additive manufacturing” refers to any process in which a three-dimensional object is formed one layer at a time by addition of material to the object. Example processes include: vat polymerisation; material jetting; binder jetting; material extrusion processes such as fused filament fabrication; sheet lamination processes such as ultrasonic additive manufacturing and laminated object manufacturing; directed energy deposition three-dimensional printing processes such as laser engineered net shaping; and powder bed fusion processes, such as direct metal laser sintering, electron beam melting, selective heat sintering, selective laser melting and selective laser sintering.

In a preferable arrangement, additive manufacture may involve depositing particles, and sintering deposited particles, for example by using an energy beam. Example energy beams include an electron beam or electromagnetic radiation, such as a laser beam, which is used to sinter or melt a powder material. A three-dimensional conductor may be formed, from a digital model or another electronic data source, through additive processes in which successive layers or regions of material are laid down and subsequently solidified. A laser beam or electron beam may be used to fuse a previously-levelled powder surface layer into a thin sheet of solid material. A further layer of powder may be applied on top of the previously-fused thin sheet and the process may be repeated until a three-dimensional object is built layer-by-layer. This may be referred to as powder bed fusion (PBF), laser selective melting, or direct laser metal sintering. The additive manufacture process may be carried out in a chamber filled with an inert gas to prevent unwanted chemical reactions or the oxidation of molten metal.

The zones of higher electrical conductivity 520 of the conductor 500 may comprise a plurality of sintered particles 521. As such, the zones of higher electrical conductivity 520 may have a microstructure indicative of having been sintered or melted from particles.

The zone of lower electrical conductivity 510 may comprise a plurality of particles 511. The particles 511 may be un-sintered or partially sintered. The discontinuities may be voids or pores 512 between the particles 511. Alternatively or in addition, the discontinuities may be manufactured gaps, cracks or micro-cracks, for example as demonstrated in the zones of lower electrical conductivity 510 in FIG. 5.

The zone or zones of lower electrical conductivity 510 may comprise a series of particles which are substantially homogeneous, for example as shown in the right and left zones of lower conductivity 510, having particles 511 and pores 512, in FIG. 2. Alternatively, one or more zones of lower conductivity 510 may have a plaited, braided or twisted arrangement, for example as indicated at 580 in FIG. 2. While only one braided region 580 in a zone of lower conductivity 510 is shown in FIG. 2, a plurality or all of the zones of lower conductivity 510 in the conductor 500 may be plaited, braided or twisted. The plaited, braided, or twisted arrangement 580 may be manufactured using additive manufacture, optionally involving sintering particles. The plaits, braids or twisted elongate strands formed in the arrangement may therefore be directly created in their plaited, braided or twisted configuration by an additive manufacturing process. A process step of plaiting, braiding or twisting previously non-plaited, braided or twisted strands to form the arrangement 580 may therefore be unnecessary, since the desired structure can be created in an additive manufacturing process, such as sintering of particles, or any other suitable additive manufacturing process.

Alternatively, or in addition, the zones of higher conductivity 520 may themselves be created so as to be in a plaited, braided or twisted configuration, in contrast to the straight extension of the zones of higher conductivity 520 in direction X shown in FIG. 2. An embodiment of a conductor 500 in which the zones of higher conductivity 520 are themselves created so as to be in a plaited, braided or twisted configuration is shown in FIG. 9. The zones of higher conductivity 520 may provide non-linear conductive paths through the conductor 500. The zones of higher conductivity 520 may substantially extend in a lengthwise direction X of the conductor 500. The zones of higher conductivity 520 may extend such that they deviate away from the lengthwise direction X, in a width-wise direction Y of the conductor 500 and/or in a depth-wise direction Z of the conductor 500. The zones of higher conductivity 520 may cross over one another, and/or weave around one another. The configuration in which the zones of higher conductivity 520 are disposed may be a regular pattern, or may be an irregular pattern. The zones of higher conductivity 520 may have one or more features as described in any other embodiment described herein. The zones of lower conductivity 510 may be provided having a matrix or filler type configuration, in which the zones of higher conductivity are disposed. The zones of lower conductivity 510 may surround, substantially separate and/or be at least partly disposed between the zones of higher electrical conductivity 520. The zones of lower conductivity 510 may hold the zones of higher conductivity 520 apart from one another. The zones of lower conductivity 510 may have one or more features as described in any other embodiment described herein.

As shown in FIG. 2, the zone of lower electrical conductivity 510 may extend in a lengthwise direction X of the conductor. The zone of lower electrical conductivity 510 may extend substantially parallel to an outer surface of the conductor 500. The zone of lower electrical conductivity 510 may extend in a lengthwise direction X of the conductor 500. The zone of lower electrical conductivity 510 may be substantially uniform along its length. There may be a plurality of zones of lower electrical conductivity 510. Preferably, the conductor 500 comprises at least three zones, preferably at least four, preferably at least five zones of lower electrical conductivity 510. In FIGS. 2, 5 and 7, three zones of lower electrical conductivity 510 are shown. The zones of lower electrical conductivity 510 may be: evenly spaced apart from one another, aligned with one another, and/or parallel to one another. The zones of lower electrical conductivity 510 may be arranged such that they do not intersect one another. The zones of lower electrical conductivity 510 may be spaced apart from one another in a width-wise direction Y of the conductor 500. The zones of lower electrical conductivity 510 may be extend in a depth-wise direction Z of the conductor 500. The zones of lower electrical conductivity 510 may be extend partially or wholly along the depth of the conductor 500.

The conductor 500 may be configured to have a substantially uniform cross-section along its length. The conductor 500 may have a substantially elongate or flat cross-section. The conductor 500 may have a rectangular cross-section, for example as shown in the figures. Where the conductor 500 has an elongate cross-section, having two longer sides defining the cross-section, and two shorter sides defining the cross-section, one or more, or each, of the zone or zones of lower electrical conductivity 510 may be arranged so as to extend partially or wholly from one longer side of the conductor 500 to the other longer side of the conductor 500. The zones of lower electrical conductivity 510 may be equally spaced between the shorter sides of the conductor 500. The skilled person will appreciate that other shapes and configurations of conductor 500 are possible.

The conductor 500 may have a substantially uniform chemical composition along its length, width and/or depth. The conductive material of the zone of lower electrical conductivity 520 may have substantially the same chemical composition as the material of the zones of higher electrical conductivity 510.

One or more bridging portions 530 may be provided across or through the zone(s) of lower electrical conductivity 510, for example as shown in FIG. 2, to mechanically connect the zones of higher electrical conductivity 520 to one another. Bridging portions 530 across or through different zones of lower electrical conductivity 510 may be spaced apart from one another in a lengthwise direction X of the conductor 500, for example as shown in FIG. 2. Provision of one or more bridging portions 530 may improve the structural properties of the conductor 500. Equally, the conductor 500 may be devoid of bridging portions 530. A conductor 500 devoid of bridging portions 530 may have reduced losses.

The zone or zones of lower electrical conductivity 510 may be arranged so as to reduce eddy currents within the conductor 500, for example by providing a resistive barrier to current flow in a direction other than lengthwise X in the conductor 500. The zones of higher and lower electrical conductivity 520, 510, are preferably arranged so as to inhibit lateral current flow within the conductor 500. The zones of higher and lower electrical conductivity 520, 510 are preferably arranged so as to permit longitudinal, or lengthwise, current flow within the conductor 500. The zone or zones of lower electrical conductivity 510 are preferably arranged so as to mimic insulative layers between conductors in a Litz conductor arrangement. This may be, for example, by being arranged in a sinusoidal or helical arrangement.

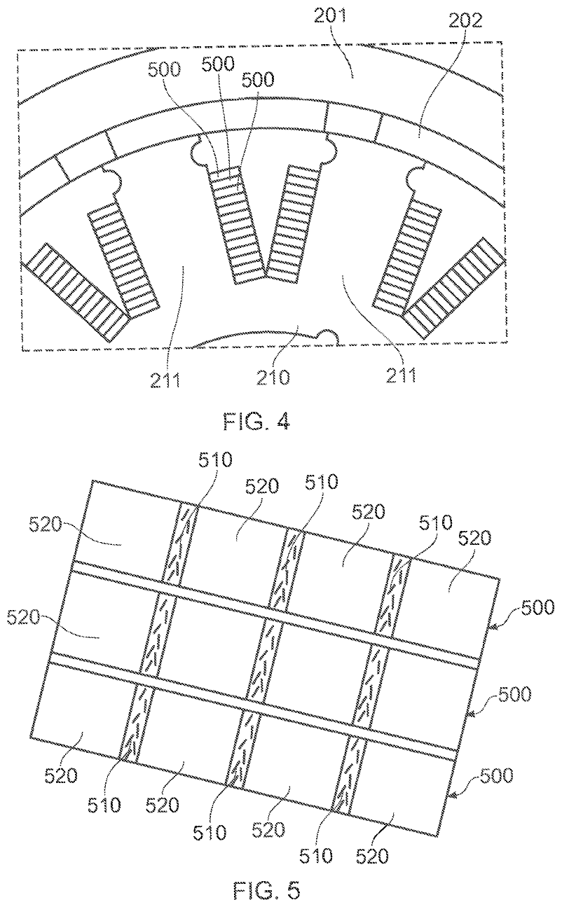

As noted previously, the conductor 500 may be used in different embodiments of an electric machine. FIG. 3 shows a partial cut-through of a first embodiment of an electric machine 200. The first embodiment electric machine 200 may comprise a rotor 201 and a stator 210. In contrast to the electric machine shown in FIG. 1, the rotor 201 may be disposed outside the stator, though the skilled person will appreciate that variations of the rotor 201 and stator 210 relative arrangement and configuration are permissible with the invention. The rotor 201 may comprise a plurality of fixed magnets 202. The stator 210 may comprise a plurality of posts 211. The conductor(s) 500 may be provided within windings, around one or more posts 211. The conductor(s) 500 may be arranged in a helical or substantially helical arrangement around one or more posts 211. As shown in FIGS. 4 and 5, the conductor 500 may be wound around to be stacked upon itself. Where there is a plurality of conductors 500, the conductors 500 may be stacked upon one another. Where the conductor 500 has an elongate cross-section, such as a rectangular cross-section, the longer sides of the conductor 500 may be juxtaposed or aligned with one another.

Along a lengthwise direction X of the conductor 500, there may be at least one area without any zone of lower electrical conductivity 510. The at least one area without any zone of lower electrical conductivity 510 may be an area of the conductor that is not subjected to the highest electromagnetic field. With reference to the embodiment of FIG. 3, the windings may have a first area 508 between posts 211 and/or rotor 201, and a second area 509 outside of the posts 211 and/or rotor 201. The first area 508 may have a substantially straight shape. Specifically, the conductor(s) in the first area 508 may be substantially straight. The second area 509 may be substantially curved. Around each post 211, there may be provided two first areas 508 and two second areas 509, which may together surround the post 211 in a circular arrangement. The first area 508 may be subjected to a higher magnetic field than the second area 509. The conductor(s) 500 in the first area 508 may comprise one or more zones of lower electrical conductivity 510. The conductor(s) in the second area 509 may be devoid of zones of lower electrical conductivity 510. The conductor(s) 500 in the second area 509 may comprise, substantially contain, or consist of, zones of higher electrical conductivity 520.

Alternatively, or in addition, to the distribution of zones in first and second areas 508, 509, the conductor or conductors 500 may be devoid of zones of lower conductivity 510 in a radially outer region of the winding, and may only have zones of higher conductivity 520. In a radially inner region of the winding, the conductor or conductors 500 may comprise zones of lower conductivity 510 and zones of higher conductivity 520. In a radially inner region of the winding, the conductor or conductors 500 may comprise a distribution of zones of lower conductivity 510 and zones of higher conductivity 520 as described in relation to the first and second areas 508, 509.

A second embodiment of an electric machine 300 is shown in FIG. 6. The second embodiment electric machine 300 may comprise a rotor 301 and a stator 310. In contrast to the electric machine shown in FIG. 3, the rotor 301 may be disposed inside the stator 310, though the skilled person will appreciate that variations of the rotor 301 and stator 310 relative arrangement and configuration are permissible with the invention. The rotor 301 may comprise a plurality of fixed magnets. The stator 310 may comprise a plurality of slots 311. The conductor(s) 500 may be provided within the plurality of slots 311. Each slot 311 may comprise an inner section 315 and an outer section 316, for example as shown in FIG. 7. A conductor 500 may be provided in each of the inner and outer sections 315, 316. Where the or each conductor 500 has an elongate configuration, the or each conductor 500 may be oriented to extend in the direction of the slot that it occupies 311, i.e. in a radial direction of the electric machine 300. The or each conductor 500 may be configured to substantially align with an inner wall of the slot 311 it occupies. The zones of lower electrical conductivity 510 may be equally spaced and distributed from one another, for example as shown in FIG. 7. However, in the second embodiment electric machine, the zones of lower electrical conductivity 510 may be concentrated towards a radially inner part of the or each slot 311. This may mitigate eddy currents that would otherwise be present in these inner regions. A radially outer region of the or each slot 311 may be devoid of zones of lower electrical conductivity 510, or may comprise or consist of zones of higher electrical conductivity 520.

As the skilled person will appreciate from the description and figures, the conductor 500 of the present invention has the advantage of reducing energy losses from eddy currents and skin effects, while permitting sufficient current flow in the intended direction through the conductor 500. In some embodiments, for example in inverter-driven machines running at 1 kHz fundamental frequency, the conductor 500 of the present invention has the advantage of reducing energy losses from eddy currents. The conductor 500 is also easy and cheap to manufacture, by virtue of its simplicity, and because the arrangement is conducive to additive manufacture, optionally with a single particulate starting material.

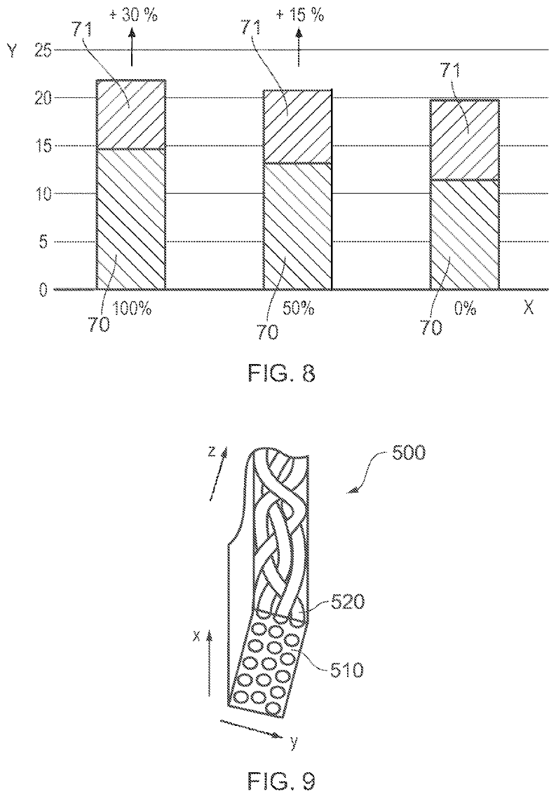

FIG. 8 is a model demonstrating performance of two examples against the claimed conductor. Axis X is International Annealed Copper Standard (“IACS”) of a layer within the conductor, and axis Y is percentage energy losses. Sections 70 represent AC losses, and sections 71 represent DC losses. FIG. 8 shows a comparison of three conductors: a regular copper bar, having homogeneous copper instead of any zone of lower conductivity (“100%”, referring to 100% IACS, of the homogeneous copper), and an example having a perfect insulating layer instead of a zone of lower conductivity between zones of homogeneous copper (“0%”, referring to 0% IACS of the perfect insulating layer). The performance, in terms of energy losses, of an embodiment of the claimed conductor (“50%”, referring to 50% IACS of the zone of lower conductivity between zones of homogeneous copper) is between these two examples. As shown in FIG. 8, performance of an embodiment of the claimed conductor is better than standard bar copper (100%), while manufacturing is easier and cheaper than for a Litz wire or other laminate or insulated alternative. In all of these arrangements, the electrical conductivity along a lengthwise direction of the homogeneous copper is the same. However, since the zone of lower conductivity and the insulating layer are present and have a non-zero cross-section along a width of the conductor, lengthwise electrical conductivity of the conductor as a whole may vary between the three conductors demonstrated in this figure.

Although a specific form and arrangement of conductor, and electric machines, and method is described and shown in the figures, it will be appreciated that various aesthetic, structural, and operational changes could be made to the aspects and embodiments shown whilst still performing the function of the present invention as defined in the appended claims. Other variations on the conductors shown and described can be envisaged without departing from the scope of protection as defined in the appended claims.

Where the word ‘or’ appears, this is to be construed to mean ‘and/or’ such that items referred to are not necessarily mutually exclusive and may be used in any appropriate combination.

Reference numerals used in the claims should be construed as a guide to a possible embodiment or embodiments only, and not be construed as limiting on the scope of the claims.

1. A conductor for an electric machine, the conductor comprising:
two zones of higher electrical conductivity; and
a zone of lower electrical conductivity with an electrically conductive material having a plurality of discontinuities to provide the zone of lower electrical conductivity with a lower electrical conductivity than the zones of higher electrical conductivity;
wherein the zone of lower electrical conductivity is disposed between the zones of higher electrical conductivity, so as to at least partly separate the zones of higher electrical conductivity along a lengthwise direction of the conductor, so as to inhibit lateral current flow and to permit longitudinal current flow in the conductor to reduce eddy current effects.

2. The conductor of claim 1, wherein the conductor is additively manufactured.

3. The conductor of claim 1, wherein the conductive material has substantially the same chemical composition as the material of the zones of higher electrical conductivity.

4. The conductor of claim 1, wherein:
the zone of lower electrical conductivity comprises a plurality of particles, the discontinuities are pores between the particles, and the zones of higher electrical conductivity comprise a plurality of sintered particles; or
the discontinuities comprise voids, gaps, cracks or micro-cracks.

5. The conductor of claim 1, wherein along a lengthwise direction of the conductor, there is at least one longitudinal portion or area without any zone of lower electrical conductivity.

6. The conductor of claim 1, wherein the zone of lower electrical conductivity extends in a lengthwise direction of the conductor, substantially parallel to an outer surface of the conductor, and wherein the zone of lower electrical conductivity is preferably substantially uniform along its length.

7. The conductor of claim 1, wherein one or more bridging portions are provided across the zone of lower electrical conductivity, to mechanically and/or electrically connect the zones of higher electrical conductivity to one another.

8. The conductor of claim 7, comprising a plurality of zones of lower electrical conductivity, preferably at least three zones of lower electrical conductivity.

9. The conductor of claim 8, wherein bridging portions across different zones of lower electrical conductivity are spaced apart from one another in a lengthwise direction of the conductor.

10. The conductor of claim 1, comprising at least three zones of higher electrical conductivity.

11. The conductor of claim 1, wherein the zone or zones of lower electrical conductivity are arranged so as to reduce eddy currents within the conductor;
wherein the zones of higher and lower electrical conductivity are preferably arranged so as to inhibit lateral current flow within the conductor, and to permit longitudinal current flow within the conductor; and
wherein the zone or zones of lower electrical conductivity are preferably arranged so as to mimic insulative layers between conductors in a Litz conductor arrangement, such as by being arranged in a sinusoidal or helical arrangement.

12. An electric machine comprising windings, the windings comprising the conductor of claim 1;
wherein the electric machine comprises a rotor and a stator, the conductor being disposed in a slot or plurality of slots within the rotor or stator, and an area of the conductor within the slot or slots has zones of lower electrical conductivity.

13. A method of manufacturing a conductor for an electric machine, comprising:
forming two zones of higher electrical conductivity; and
forming a zone of lower electrical conductivity with an electrically conductive material having a plurality of discontinuities in the electrically conductive material to provide the zone of lower electrical conductivity with a lower electrical conductivity than the zones of higher electrical conductivity;
such that the zone of lower electrical conductivity is disposed between the zones of higher electrical conductivity, so as to at least partly separate the zones of higher electrical conductivity along a lengthwise direction of the conductor, so as to inhibit lateral current flow and to permit longitudinal current flow in the conductor to reduce eddy current effects.

14. The method of claim 13, wherein forming the zones of higher electrical conductivity, and/or forming the zone of lower electrical conductivity, is performed using additive manufacture.

15. The method of claim 13, wherein forming the zone of lower electrical conductivity involves depositing particles; and/or
wherein forming the zones of higher electrical conductivity involves depositing particles and sintering the deposited particles.
